(19) United States
(12) Patent Application Publication
(10) Pub. No.: US 2023/0397274 A1
(43) Pub. Date: Dec. 7, 2023

(54) METHOD FOR OPTIMIZING MULTIPLE LINK OPERATION BY ADJUSTING LINK PLAN AND NUMBER OF SPATIAL STREAMS

(71) Applicant: MEDIATEK INC., Hsin-Chu (TW)

(72) Inventors: Chien-Chih Chen, Hsinchu (TW); Chia-Shun Wan, Hsinchu City (TW); I-Cheng Tsai, Hsinchu City (TW)

(73) Assignee: MEDIATEK INC., Hsin-Chu (TW)

(21) Appl. No.: 18/143,612

(22) Filed: May 5, 2023

Related U.S. Application Data
(60) Provisional application No. 63/347,594, filed on Jun. 1, 2022.

(51) Int. Cl. H04W 76/15

(52) U.S. Cl. CPC H04W 76/15

(57) ABSTRACT

The present invention provides a wireless communication method of an electronic device, wherein the wireless communication method includes the steps of: determining one link plan from a plurality link plans; using the determined link plan as a current link plan to configure a first link and a second link of the electronic device; determining whether the current link plan satisfies a first condition; in response to the current link plan satisfying the first condition, determining whether performance of another link plan is better than performance of the current link plan; and in response to the performance of another link plan being better than the performance of the current link plan, determining the another as the current link plan to configure the first link and the second link of the electronic device to communicate with the another electronic device.

### CROSS REFERENCE TO RELATED APPLICATIONS

This application claims the benefit of U.S. Provisional Application No. 63/347,594, filed on Jun. 1, 2022. The content of the application is incorporated herein by reference.

### BACKGROUND

In previous Wi-Fi generations, a device can only connect to one Wi-Fi band such as 2.4 GHz (gigahertz) band, 5 GHz band or 6 GHz band. In a Wi-Fi 7 generation, a multi-link operation (MLO) is provided to establish multiple links between devices, and the MLO enables devices to simultaneously send and receive data across different frequency bands and channels. That is, two or more channels in the 2.4 GHz band, 5 GHz band or 6 GHz band can be used simultaneously, to increase the throughput of the devices.

However, the throughput, latency or robust of the MLO may be degraded if a packet error rate of one link becomes higher. Therefore, how to control the links of the MLO to keep high performance is an important topic.

### SUMMARY

It is therefore an objective of the present invention to provide a wireless communication method, which can adjust a link plan and/or special stream setting to optimize the performance of the electronic device, to solve the above-mentioned problems.

According to one embodiment of the present invention, a wireless communication method of an electronic device comprises the steps of: determining one link plan from a plurality link plans; using the determined link plan as a current link plan to configure a first link and a second link of the electronic device to communicate with another electronic device; determining whether the current link plan satisfies a first condition; in response to the current link plan satisfying the first condition, determining whether performance of another link plan is better than performance of the current link plan; and in response to the performance of another link plan being better than the performance of the current link plan, determining the another as the current link plan to configure the first link and the second link of the electronic device to communicate with the another electronic device.

According to one embodiment of the present invention, a wireless communication method of an electronic device comprises the steps of: using a current number of spatial stream (NSS) setting to configure a first link and a second link of the electronic device, wherein the first link corresponds to a first NSS, and the second link corresponds to a second NSS; determining whether the first link satisfies a condition; and in response to the first link satisfying the second condition, if the first NSS is greater than one, decreasing the first NSS of the first link and increasing the second NSS of the second link.

According to one embodiment of the present invention, a circuitry of an electronic device configured to perform the steps of: determining one link plan from a plurality link plans; using the determined link plan as a current link plan to configure a first link and a second link of the electronic device to communicate with another electronic device; determining whether the current link plan satisfies a first condition; in response to the current link plan satisfying the first condition, determining whether performance of another link plan is better than performance of the current link plan; and in response to the performance of another link plan being better than the performance of the current link plan, determining the another as the current link plan to configure the first link and the second link of the electronic device to communicate with the another electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to one embodiment of the present invention.

FIG. 2 is a flowchart of a wireless communication method according to one embodiment of the present invention.

FIG. 3 is a diagram illustrating selecting a link plan with better goodput according to one embodiment of the present invention.

FIG. 4 is a diagram illustrating switching the link plan according to one embodiment of the present invention.

FIG. 5 is a flowchart of a wireless communication method according to one embodiment of the present invention.

FIG. 6 is a diagram illustrating changing the NSS setting of the two links.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

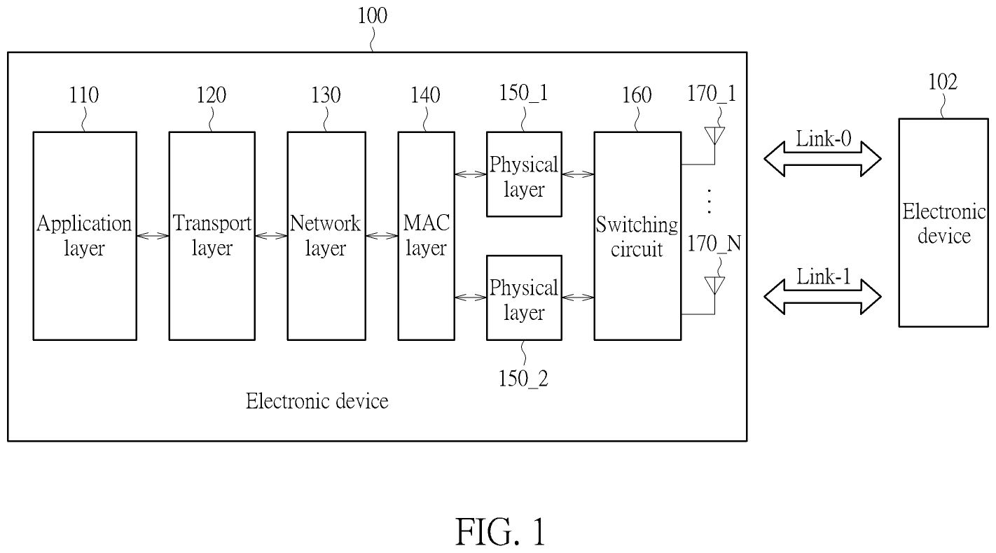

FIG. 1 is a diagram illustrating an electronic device 100 according to one embodiment of the present invention. As shown in FIG. 1, the electronic device 100 comprises a circuitry comprising an application layer 110, a transport layer 120, a network layer 130, a media access control (MAC) layer 140, two physical layers 15_1 and 150_2, a switching circuit 160 and a plurality of antennas 170_1-170_N. In this embodiment, the electronic device 100 can be a notebook, a cell phone or any other electronic device capable of wirelessly communicate with other device(s) such as an electronic device 102.

In this embodiment, the electronic device 100 supports the MLO of Wi-Fi 7 generation, that is, the electronic device 100 can establish two or more links with the electronic device 102, and simultaneously send and receive packets via these two or more links. FIG. 1 shows that the electronic device 100 has two physical layers 150_1 and 150_2 configured to establish two links Link-0 and Link-1, respectively, wherein Link-0 may use a channel corresponding to a 2.4 GHz band (e.g., 2.412 GHz-2.484 GHz), a 5 GHz band (e.g., 4.915 GHz-5.825 GHz) or a 6 GHz band (e.g., 5.925 GHz-7.125 GHz); and Link-1 may also use a channel corresponding to the 2.4 GHz band, the 5 GHz band or the 6 GHz band.

In addition, the switching circuit 160 is configured to couple the physical layer 150_1 to a portion of the plurality of antennas 170_1-170_N, and couple the physical layer 150_2 to the other portion of the plurality of antennas 170_1-170_N, to determine a number of spatial stream (NSS) of the Link-0 and an NSS of the Link-1. For example, if the electronic device 100 has four antennas 170_1-170_4, the switching circuit 160 may couple the physical layer 150_1 to the antennas 170_1-170_2, and couple the physical layer 150_2 to the antennas 170_3-170_4, so that the Link-0 has two spatial streams (NSS=2), and the Link-1 has two spatial streams (NSS=2). In addition, the switching circuit 160 may couple the physical layer 150_1 to the antennas 170_1-170_3, and couple the physical layer 150_2 to the antenna 170_4, so that the Link-0 has three spatial streams (NSS=3), and the Link-1 has only one spatial stream (NSS=1).

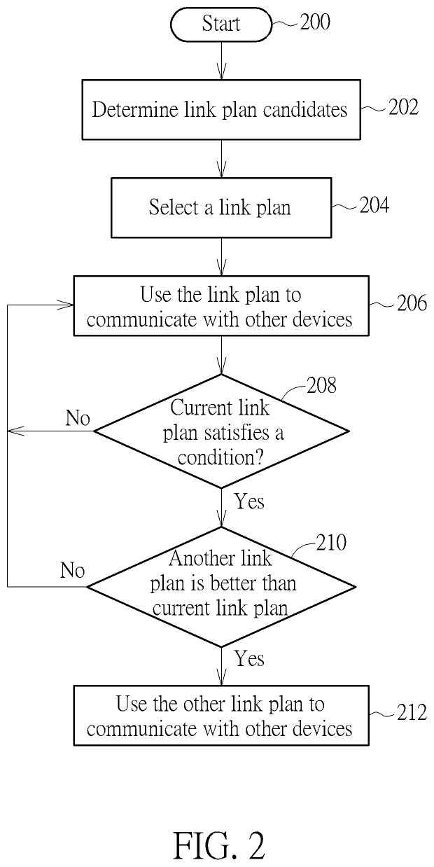

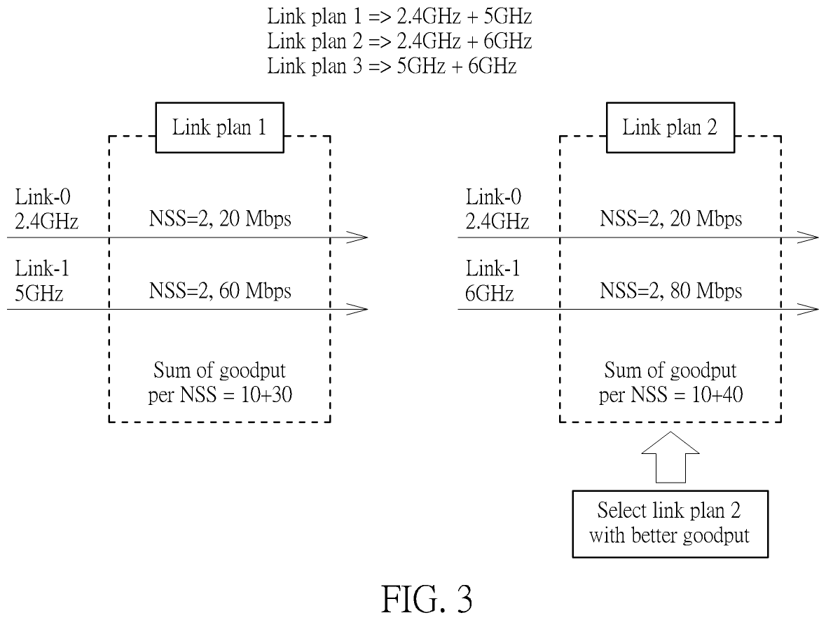

FIG. 2 is a flowchart of a wireless communication method according to one embodiment of the present invention. In Step 200, the flow starts, and the electronic device 100 is powered on and a wireless communication mechanism is enabled. In Step 202, a control circuit within the MAC layer 140 determines link plan candidates. Taking FIG. 3 as an example, assuming that the electronic device 100 comprises only two physical layers 150_1 and 150_2, and three frequency bands can be used for wireless communication, the electronic device 100 may have three link plan candidates, wherein the first link plan uses both the 2.4 GHz band the 5 GHz band to communicate with the electronic device 102, that is, one of the Link-0 and Link-1 uses a channel of the 2.4 GHz band, and the other one of the Link-0 and Link-1 uses a channel of the 5 GHz band; the second link plan uses both the 2.4 GHz band the 6 GHz band to communicate with the electronic device 102, that is, one of the Link-0 and Link-1 uses a channel of the 2.4 GHz band, and the other one of the Link-0 and Link-1 uses a channel of the 6 GHz band; and the third link plan uses both the 5 GHz band the 6 GHz band to communicate with the electronic device 102, that is, one of the Link-0 and Link-1 uses a channel of the 5 GHz band, and the other one of the Link-0 and Link-1 uses a channel of the 6 GHz band.

In Step 204, the control circuit within the MAC layer 140 selects a link plan from the link plan candidates according to performance of the link plan candidates. Specifically, the circuit within the MAC layer 140 may periodically detect the performance of the link plan candidates, or the MAC layer 140 uses the recorded performance of the previous connections, for the selection of the link plan. Taking FIG. 3 as an example, assuming that only the first link plan and the second link plan serve as the link plan candidates, initially the Link-0 uses the channel of the 2.4 GHz with NSS=2, and the Link-1 uses the channel of the 5 GHz with NSS=2, to communicate with the electronic device 102, and the MAC layer 140 or the physical layers 150_1 and 150_2 determine goodput or throughput of the Link-0 and the Link-1, wherein the throughput is the rate at which data traverses a link, and the goodput is the rate at which useful data traverses a link (the goodput is used in the following description, but the goodput in the following description can be replaced by throughput). In this embodiment, the goodput of the Link-0 is 20 Mbps (megabits per second), and the goodput of the Link-1 is 60 Mbps, so the goodput of the Link-0 per NSS is equal to 10 Mbps, and the goodput of the Link-1 per NSS is equal to 30 Mbps. The MAC layer 140 or the physical layers 150_1 and 150_2 can calculate a sum of the goodput of the Link-0 and the goodput of the Link-1 per NSS as the performance of the first link plan. Then, the Link-0 uses the channel of the 2.4 GHz with NSS=2, and the Link-1 uses the channel of the 6 GHz with NSS=2, to communicate with the electronic device 102, and the MAC layer 140 or the physical layers 150_1 and 150_2 determine goodputs or throughputs of the Link-0 and the Link-1. In this embodiment, the goodput of the Link-0 is 20 Mbps, and the goodput of the Link-1 is 80 Mbps, so the goodput of the Link-0 per NSS is equal to 10 Mbps, and the goodput of the Link-1 per NSS is equal to 40 Mbps. The MAC layer 140 or the physical layers 150_1 and 150_2 can calculate a sum of the goodput of the Link-0 and the Link-1 per NSS as the performance of the second link plan. Based on the performance of the first link plan and the second link plan mentioned above, the control circuit within the MAC layer 140 can determine a link plan with better performance for further use. In this embodiment, because the goodput of the second link plan per NSS is greater than the goodput of the first link plan per NSS, the second link plan is selected, wherein “the goodput of the first/second link plan per NSS” can be the sum of the goodput of the Link-0 per NSS and the goodput of the Link-1 per NSS, or an average goodput of the Link-0 and Link-1 per NSS.

In Step 206, the MAC layer 140 and the physical layers 150_1 and 150_2 use the second link plan for the wireless communication with the electronic device 102, that is, the Link-0 uses the channel of the 2.4G band, and the Link-1 uses the channel of the 6G band.

In Step 208, the MAC layer 140 determines if the current link plan satisfies at last one condition, if yes, the flow enters Step 210; and if not, the flow goes back to Step 206. In this embodiment, the at least one condition may indicate that the performance of the current link plan is lower than a threshold. For example, the MAC layer 140 may determine if a packet error rate (PER) of the Link-0 and the Link-1 is greater than a threshold value such as 50%, wherein the current link plan satisfies the condition if the PER of the current link Link-0 and the Link-1 is greater than the threshold value; or the MAC layer 140 may determine if the goodput of the current link plan is lower than a threshold value, wherein the current link plan satisfies the condition when the goodput of the current link plan is lower than the threshold value.

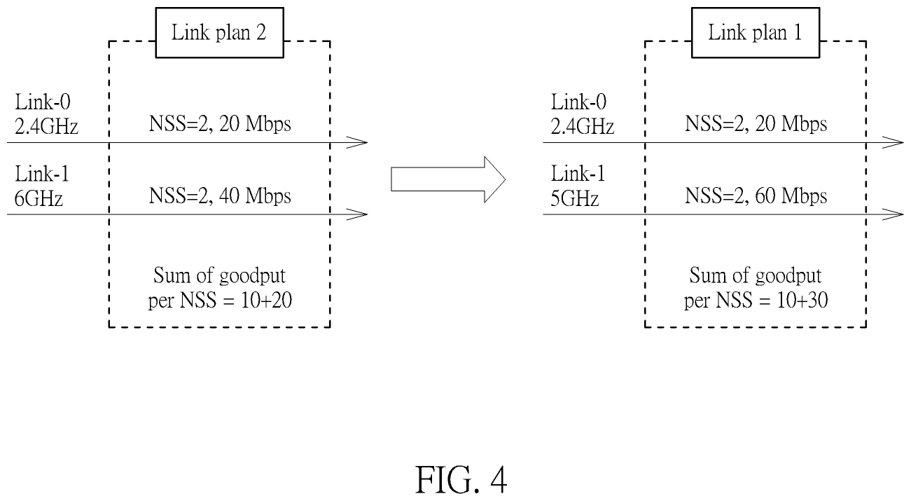

In Step 210, the MAC layer 140 determines if another link plan is better than the current link plan, if yes, the flow enters Step 212; and if not, the flow goes back to Step 206. In Step 212, the MAC layer 140 and the physical layers 150_1 and 150_2 switch to the other link plan from the current link plan. Taking FIG. 4 as an example, by using the performance of the first link plan and the second link plan that is detected before, the goodput of the second link plan per NSS is degraded to be 30 Mbps, and the goodput of the first link plan per NSS is 40 Mbps. Therefore, since the goodput of the first link plan per NSS is greater than the goodput of the current link plan (second link plan) per NSS, the MAC layer 140 and the physical layers 150_1 and 150_2 switch to the first link plan.

In light of above, by using the embodiment shown in FIG. 2, the electronic device 100 can adaptively use the link plan with better goodput, to make the electronic device 100 have the best performance.

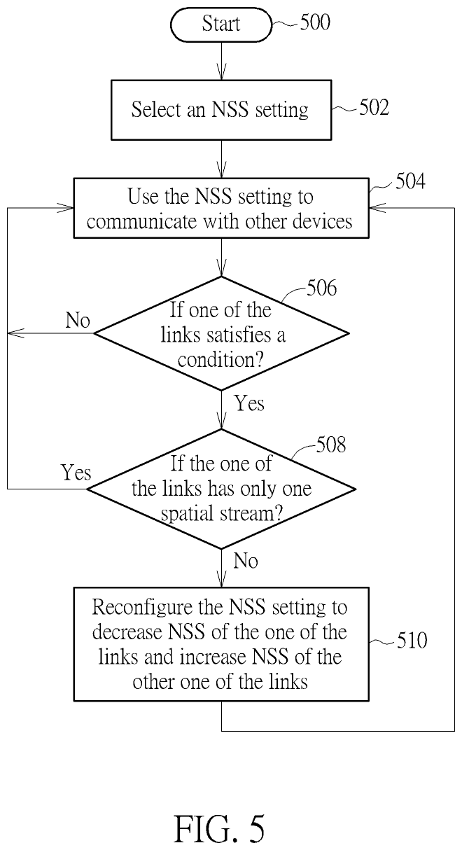

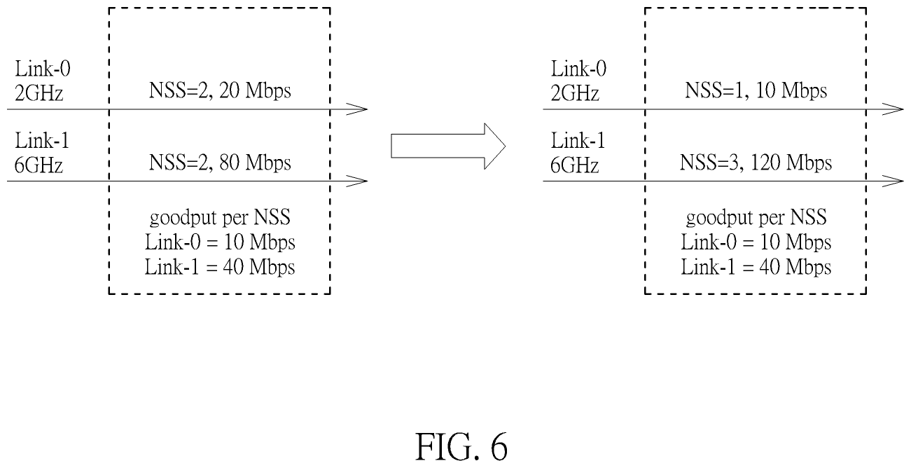

In addition, after the link plan is determined and used, the MAC layer 140 and the physical layers 150_1 and 150_2 can further determine the NSS of each link dynamically, to optimize the goodput/throughput of the two links. FIG. 5 is a flowchart of a wireless communication method according to one embodiment of the present invention, wherein the flowchart of FIG. 5 can be part of the Step 202 and/or Step 212 shown in FIG. 2. In Step 500, the flow starts. In Step 502, the MAC layer 140 or the physical layers 150_1 and 150_2 determine an NSS setting. Taking FIG. 6 as an example, assuming that electronic device 100 has four antennas 170_1-170_4, and the second link plan is used, initially the switching circuit 160 is configured to have a default setting, that is the Link-0 corresponds to a channel of 2.4 GHz band with NSS=2, and the Link-1 corresponds to a channel of 6 GHz band with NSS=2.

In Step 504, the MAC layer 140 and the physical layers 150_1 and 150_2 use the NSS setting determined in Step 502 to communicate with the electronic device 102.

In Step 506, the MAC layer 140 or the physical layers 150_1 and 150_2 determine if one of the links satisfies at last one condition, if yes, the flow enters Step 508; and if not, the flow goes back to Step 504. In this embodiment, the at least one condition may indicate that the performance of two links are unbalanced. In one embodiment, the MAC layer 140 or the physical layers 150_1 and 150_2 may determine if a difference between the goodput of the Link-0 per NSS and the goodput of the Link-1 per NSS is greater than a threshold, and if the difference is greater than the threshold, the link with lower throughput satisfies at last one condition. For example, the MAC layer 140 or the physical layers 150_1 and 150_2 may determine if the goodput of one link is lower than the goodput of the other link multiplied by a ratio, wherein the ratio is between zero and one, such as value ranging from 0.5 to 0.8. Referring to FIG. 6, assuming that the ratio is 0.5, because the goodput of the Link-0 is lower than the goodput of the Link-1 multiplied by a ratio (i.e., 10 Mbps<40 Mbps*0.5), the Link-0 satisfies the at least one condition.

In Step 508, the MAC layer 140 or the physical layers 150_1 and 150_2 determines if the one of the links has only one spatial stream (NSS=1), if yes, the flow goes back to Step 504; and if not, the flow enters Step 510.

In Step 510, the MAC layer 140 and the or the physical layers 150_1 and 150_2 reconfigure the NSS setting to lower the NSS of the one link, and increase the NSS of the other link, that is one antenna of the one link is switched to the other link. Taking FIG. 6 as an example, initially the Link-0 is configured to have only one spatial stream (NSS=1), then the MAC layer 140 and the or the physical layers 150_1 and 150_2 adjust the NSS of the Link-0 and the NSS of the Link-1 to be “1” and “3”, respectively, then the Link-1 is configured to have three spatial streams (NSS=3). As shown in FIG. 6, by adjusting the NSS of the Link-0 and the NSS of the Link-1, the sum of the goodputs of the two links become better (i.e., from 100 Mbps to 130 Mbps).

In addition, the Step 508 is performed to avoid traffic loss when the NSS setting is changed. That is, even if the goodput of the Link-1 is much better than the goodput of the Link-0, the Link-0 must have at least one spatial stream.

Briefly summarized, in the wireless communication method of the present invention, by monitoring the goodputs/throughputs of two or more links, the electronic device can know which link's goodput/throughput has dropped, so that the electronic device can adjust the link plan and/or the NSS setting to improve the performance.

Those skilled in the art will readily observe that numerous modifications and alterations of the device and method may be made while retaining the teachings of the invention. Accordingly, the above disclosure should be construed as limited only by the metes and bounds of the appended claims

What is claimed is:

1. A wireless communication method of an electronic device, comprising:
determining one link plan from a plurality link plans;
using the determined link plan as a current link plan to configure a first link and a second link of the electronic device to communicate with another electronic device;
determining whether the current link plan satisfies a first condition;
in response to the current link plan satisfying the first condition, determining whether performance of another link plan is better than performance of the current link plan; and
in response to the performance of another link plan being better than the performance of the current link plan, determining the another as the current link plan to configure the first link and the second link of the electronic device to communicate with the another electronic device.

2. The wireless communication method of claim 1, wherein the electronic device supports at least three bands, and the plurality of link plans comprises a plurality of combinations including two different bands.

3. The wireless communication method of claim 2, wherein the electronic device supports at least a 2.4 GHz band, a 5 GHz band and a 6 GHz band; and the plurality of link plans comprises a first link plan including the 2.4 GHz band and the 5 GHz, a second link plan including the 2.4 GHz band and the 6 GHz band, and a third link plan including the 5 GHz and the 6 GHz band.

4. The wireless communication method of claim 1, wherein the step of determining whether the current link plan satisfies the first condition comprises:
determining whether a packet error rate of the first link and the second link is greater than a threshold, or whether a goodput or a throughput of the first link and the second link is lower than a threshold.

5. The wireless communication method of claim 1, wherein the step of determining whether the performance of the another link plan is better than the performance of the current link plan comprises:
determining whether a goodput or a throughput of the another link plan is better than the goodput or the throughput of the current link plan.

6. The wireless communication method of claim 1, further comprising:
using a current number of spatial stream (NSS) setting to configure the first link and the second link, wherein the first link corresponds to a first NSS, and the second link corresponds to a second NSS;
determining whether the first link satisfies a second condition; and
in response to the first link satisfying the second condition, if the first NSS is greater than one, decreasing the first NSS of the first link and increasing the second NSS of the second link.

7. The wireless communication method of claim 6, further comprising:
in response to the first link satisfying the second condition, if the first NSS is equal to one, not decreasing the first NSS of the first link and not increasing the second NSS of the second link.

8. The wireless communication method of claim 6, wherein the step of determining whether the first link satisfies the second condition comprises:
determining whether a difference between a goodput/throughput of the first link and a goodput/throughput of the second link is greater than a threshold.

9. The wireless communication method of claim 8, wherein the step of determining whether the difference between the goodput/throughput of the first link and the goodput/throughput of the second link is greater than the threshold comprises:
determining whether the difference between the goodput/throughput of the first link per NSS and the goodput/throughput of the second link per NSS is greater than the threshold.

10. A wireless communication method of an electronic device, comprising:
using a current number of spatial stream (NSS) setting to configure a first link and a second link of the electronic device, wherein the first link corresponds to a first NSS, and the second link corresponds to a second NSS;
determining whether the first link satisfies a condition; and
in response to the first link satisfying the second condition, if the first NSS is greater than one, decreasing the first NSS of the first link and increasing the second NSS of the second link.

11. The wireless communication method of claim 10, further comprising:
in response to the first link satisfying the second condition, if the first NSS is equal to one, not decreasing the first NSS of the first link and not increasing the second NSS of the second link.

12. The wireless communication method of claim 10, wherein the step of determining whether the first link satisfies the second condition comprises:
determining whether a difference between a goodput/throughput of the first link and a goodput/throughput of the second link is greater than a threshold.

13. The wireless communication method of claim 12, wherein the step of determining whether the difference between the goodput/throughput of the first link and the goodput/throughput of the second link is greater than the threshold comprises:
determining whether the difference between the goodput/throughput of the first link per NSS and the goodput/throughput of the second link per NSS is greater than the threshold.

14. A circuitry of an electronic device, configured to perform the steps of:
determining one link plan from a plurality link plans;
using the determined link plan as a current link plan to configure a first link and a second link of the electronic device to communicate with another electronic device;
determining whether the current link plan satisfies a first condition;
in response to the current link plan satisfying the first condition, determining whether performance of another link plan is better than performance of the current link plan; and
in response to the performance of another link plan being better than the performance of the current link plan, determining the another as the current link plan to configure the first link and the second link of the electronic device to communicate with the another electronic device.

15. The circuitry of claim 14, wherein the electronic device supports at least three bands, and the plurality of link plans comprises a plurality of combinations including two different bands.

16. The circuitry of claim 15, wherein the electronic device supports at least a 2.4 GHz band, a 5 GHz band and a 6 GHz band; and the plurality of link plans comprises a first link plan including the 2.4 GHz band and the 5 GHz, a second link plan including the 2.4 GHz band and the 6 GHz band, and a third link plan including the 5 GHz and the 6 GHz band.

17. The circuitry of claim 14, wherein the step of determining whether the current link plan satisfies the first condition comprises:
determining whether a packet error rate of the first link and the second link is greater than a threshold, or whether a goodput or a throughput of the first link and the second link is lower than a threshold.

18. The circuitry of claim 14, wherein the step of determining whether the performance of the another link plan is better than the performance of the current link plan comprises:
determining whether a goodput or a throughput of the another link plan is better than the goodput or the throughput of the current link plan.
